(19) United States
(12) Patent Application Publication
(10) Pub. No.: US 2010/0178377 A1
(43) Pub. Date: Jul. 15, 2010

(54) INJECTION MECHANISM, INJECTION MOLDING MACHINE AND OPTICAL ELEMENT

(75) Inventors: Shigeru Hosoe, Tokyo (JP); Takemi Miyazaki, Tokyo (JP); Yuiti Fujii, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC., Hachioji-shi, Tokyo (JP)

(21) Appl. No.: 12/663,833

(22) PCT Filed: May 30, 2008
(86) PCT No.: PCT/JP2008/060010

§ 371 Date: Dec. 9, 2009

(30) Foreign Application Priority Data
Jun. 14, 2007 (JP) 2007-157307

(51) Int. Cl. B29C 45/20

(52) U.S. Cl. 425/559

(57) ABSTRACT

In repeating strokes for injecting a resin material, a piston (13) is slid to an inlet position (P2) within a cylinder (12). Accordingly, when the piston (13) is moved backward further, the resin near the piston (13) is replaced with a fresh resin supplied from a resin reservoir section (RT). Therefore, in the subsequent injection stroke, only the fresh resin can be always injected. Thus, there is no possibility that the rein stays beyond the pot-life and starts to cure or causes an increase in viscosity within the cylinder (12). Further, any foreign matter such as a semi-cured resin is not produced. Therefore, clogging of the resin passage and the flow of the foreign matter into a molding cavity can be suppressed. As a result, given molding conditions can be always ensured, and, thus, highly accurate molding products can be produced with high reproducibility.

### TECHNICAL FIELD PERTAINING TO THE INVENTION

The present invention relates to a molding technology and in particular to an injection mechanism, an injection molding machine and an optical element formed by injection molding.

### PRIOR ART

An injection molding machine to perform injection mold of highly accurate optical elements using resin is known. In a common injection molding machine, as Patent Document 1 (Unexamined Japanese Patent Application Publication No. 2006-272558) shows, a movable metal mold mounted on a movable die plate is pressed against a fixed metal mold mounted on a fixed die plate. Then, by firmly contacting an injection nozzle with an outside of the fixed metal mold, a resin is injected into a cavity of the metal mold with high pressure through a nozzle hole of the injection nozzle and a spool of the fixed metal mold and cured. Whereby, the common molding machine forms molding products efficiently.

Patent Document 1: Unexamined Japanese Patent Application Publication No. 2006-272558

### DISCLOSURE OF THE INVENTION

### Problems to be Solved by the Invention

As a technology to feed the resin with high pressure, a technology shown in FIG. 10 is cited. The technology shown in FIG. 10 uses a screw. The screw is used for ejecting energy curable resin materials such as heat plasticity resin materials and thermosetting resin materials. The technology shown by FIG. 10 will be described specifically. By rotating a screw SW disposed in a cylinder Cy, pellets PT of the resin are fed from a rear section of to a front section while being melted. The resin in a liquid state is gradually reserved in a front section of the cylinder CY, then by moving the screw SW forward at a burst, the resin is injected from the nozzle NZ disposed at a front end of the cylinder CY with a high pressure.

Usually, a mechanical shut valve SV configured with springs and sliding parts is disposed at a front end of the screw SW. The valve closes the injection flow path for the resin by sliding the slide parts with a spring force or a ram pressure so as to prevent the resin from backward flow at a time when the screw moves forward.

As above, main reasons to use the screw SW in the prior art are to forcibly feed the resin having a high viscosity in order to accumulate the resin in front of a cylinder CY, and in case of heat-plasticity resin, to melt the resin material in the shape of pellets or powder by shearing heat generated by rotation of the screw SW. Also, there is another reason to use the screw SW. That is because, an old resin is not tend to remain in the cylinder CY since the resin supplied in the cylinder CY on ahead is fed sequentially through the screw SW and injected from the front end of the cylinder CY on ahead. However, there is a problem of high production cost since the screw SW has to be machined with high accuracy and a mechanical structure for the shut valve SV has to be provided at a front end of the screw SW.

In addition, in recent years, molding using the energy curable resin materials represented by light curable resin and the thermosetting resin materials is attempted. Since the energy curable resin is cured by giving energy from an outside, the energy curable resin has a superior characteristic that once the energy curable resin has been cured, it cannot be deformed easily even if it is subject to a high temperature, which is different from ordinary thermoplasticity resins.

Therefore, since the energy curable resin is usually in a form of a liquid in room temperature and has a low viscosity, in case the aforesaid prior art is utilized, the resin in the form of a liquid passes through a gap between the screw SW and cylinder CY and flows backward easily. Thus effective feeding through the screw SW cannot be expected much. Further, since the resin easily leaks out from the shut valve SV and flows backward at the time of injection, high injection molding pressure is difficult to obtain. Thus, unlike the energy curable resin, the low viscosity resin material having a resin viscosity of 100 to 2000 mPa·S cannot be injected with high pressure, and there was a pressure limit of 5 MPa at most. Considering that the injection pressure reaches to 100 MPa in molding of the thermoplasticity resin, the pressure is too low to say that it is injection molding.

The present invention has one aspect to solve the above problems and an object of the present invention is to provide an injection mechanism and an injection molding machine which can ensure the injection pressure by suppressing backward flow of the resin, eve if the low viscosity resin is used, as well as an optical element.

### Means to Solve the Problems

An injection mechanism related to the present invention is to inject a resin material into a molding cavity used in a molding machine. The injection mechanism includes:
a reservoir section to reserve the resin material;
a cylinder having;

an outlet port to inject the resin material from the cylinder, and

an inlet port, provided at a different position from the outlet port, to supply the resin material reserved in the reservoir section in the cylinder;
a piston to slide inside the cylinder; and
a first check valve to restrict backward flow of the resin material provided between the inlet port and the reservoir section.

Also, the injection mechanism related to the present invention is to inject a resin material into a molding cavity used in a molding machine. The injection mechanism includes:
a reservoir section to reserve the resin material;

a cylinder having an outlet port to inject the resin material into the cylinder,

a piston to slide within the cylinder having a passage to supply the resin material reserved in the reservoir section to the cylinder; and

a first check valve to restrict backward flow of the resin material, located between the passage and the reservoir section;

wherein the resin material supplied via the passage is accumulate between the piston and the outlet port in the cylinder.

Also, the injection molding machine related to the present invention includes the aforesaid injection mechanism.

Further, the optical element related to the present invention is molded by the aforesaid injection molding machine.

### Effect of the Invention

According to the present invention, there can be provided the injection mechanism and the injection molding machine which can ensure the injection pressure by suppressing backward flow of the resin, eve if the low viscosity resin is used, as well as the optical element.

### BRIEF DESCRIPTION OF THE DRAWINGS

FIG. 1 is a schematic view showing an injection mechanism related to an example of the present invention.

FIG. 2 is a schematic view showing an injection mechanism related to a comparison example.

FIG. 3 is a schematic view showing an injection mechanism related to an example of the present invention.

FIG. 4 is a schematic view showing an injection mechanism related to an example of the present invention.

FIG. 5 is a schematic view showing an injection mechanism related to an example of the present invention.

FIG. 6 is a schematic view showing an injection mechanism related to an example of the present invention.

FIG. 7 is a schematic view showing an injection mechanism related to an example of the present invention.

FIG. 8 is a side view of an injection mold machine related to an embodiment of the present invention.

FIG. 9 is a perspective view of a mold machine related to an embodiment of the present invention.

FIG. 10 is a schematic view showing an injection mechanism related to prior art.

### DESCRIPTION OF THE SYMBOLS

1 Base

2 Cylinder plate

3 Movable side die plate

4 Fixed side die plate

4a Through hole

5 Tie bar

6 Mold clamping cylinder

6a Mold clamping piston

7 Movable metal mold

8 Fixed metal mold

8a Receiving surface

8b Spool

9 Moving table

10 Injection mechanism

11 Housing

11a Outlet path

11b Inlet path

11c Circumferential groove

12 Cylinder

13 Piston

13a Passage

13b Projecting section

13c Circumferential groove

14 O-ring

15′ Three-way valve

15 Second check valve

16 First check valve

17 Heater

CP Piping

NZ Injection nozzle

RT Resin reservoir section

ST Stopper

NZ Injection nozzle

### DESCRIPTION OF THE PREFERRED EMBODIMENTS

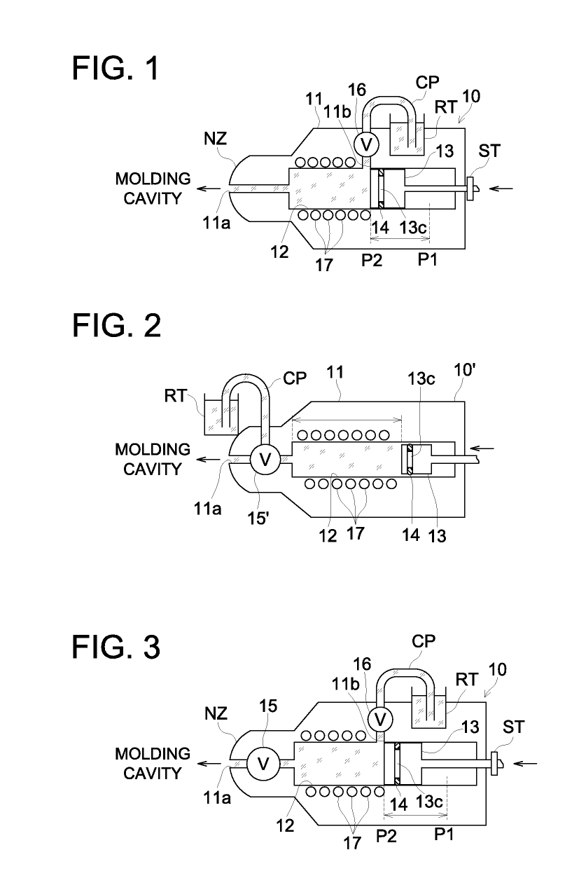

The embodiments will be described with reference to the comparison examples as follow. The FIG. 1 is a schematic view showing an injection mechanism related to an example of the present invention. FIG. 2 is a schematic view showing an injection mechanism related to a comparison example.

In FIG. 1, an injection mechanism 10 related to the embodiment of the present invention is provided with a housing 11, a cylinder 12 formed inside the housing 11 and a piston 13 capable of slide in the cylinder 12. The piston 13 is connected with an unillustrated drive source.

Incidentally, in the circumferential groove 13c formed at a circumference of the piston 13, an O-ring 14 to seal a gap between the cylinder 12 and the piston 13 is installed.

An outlet path 11a communicating with an unillustrated molding cavity is formed at a front end (left end in FIG. 1) of the cylinder 12 in the housing 11. On the other hand, in the middle of the cylinder 12 in the housing 11, an inlet path 11b connecting with an external resin reservoir section RT via a piping CP is formed. Here, an opening end which opens the outlet path 11a to inside the cylinder 12 is an outlet port and an opening end which opens the inlet path 11b to the cylinder 12 inside is an inlet port.

A first check valve 16 is disposed in the inlet path 11b. The nozzle is formed at a periphery of the outlet path 11a. Incidentally, a heater 17 representing a temperature control device to control cylinder temperature is disposed at a periphery of the cylinder 12 between the outlet port and the inlet port. The temperature control device can be a water pipe to control temperature instead of the heater 17. By providing the temperature control device, temperature control of the resin filled in the cylinder is possible and deterioration of the resin is suppressed, thus injection can be performed under a preferable condition.

On the other hand, in the injection mechanism 10′ related to the comparison example shown in FIG. 2, the inlet path 11b is connected with the external resin reservoir section RT via the piping CP, and the inlet path 11b is connected with the outlet path 11a of the cylinder 12 via the three way valve 15′. Other than the above, components are the same as that of the injection mechanism 10.

First, operation of the comparison example will be described. In FIG. 2, when the resin is filled in the cylinder 12, the three way valve 15′ is changed over so that the resin reservoir section RT and the cylinder 12 communicate each other, after that, the piston 13 is moved backward by the unillustrated drive source. Whereby, the resin is filled into the cylinder 12 from the resin reservoir section RT via the piping CP. After that, the three way valve is changed over so that an unillustrated molding cavity and the cylinder 12 communicate each other then the piston 13 is moved forward by the unillustrated drive source. Whereby, the resin filled in the cylinder 12 is fed with high pressure (injected).

Incidentally, in the aforesaid method of the comparison example, the resin filled in the cylinder 12 first is accumulated deep (piston side) in the cylinder 12 and injected late. The resin accumulated deep in the cylinder 12 remains in the outlet path 11a between three way valve 15′ and the cylinder 12, even after injection stroke of the piston 13. Thus, when the resin is filled from the resin reservoir section RT, the residual resin is pushed back into the cylinder 12 and remains in the deepest part of the cylinder 12. Therefore, there is a problem that the resin staying in the rear portion of the cylinder 12 is difficult to be replaced with a newly filled resin.

For example, in case of energy curable resin such as the thermosetting resin and the ultraviolet ray curable resin, usually, a pot-life i.e. a period where the resin doesn't change its character, is determined. A long pot-life is two to three hours and a long one is two to three weeks. Thus, in the comparison example of the injection mechanism 10′, the resin possibly stays in the cylinder beyond the pot-life. The energy curable resin staying in the cylinder beyond the pot-life starts to cure partially and when a high viscosity portion is created, the high viscosity portion possibly clogs the nozzle and the valve or reaches to the molding cavity and deteriorates quality of the product as a foreign matter.

In case of thermoplasticity resin, since the resin in the cylinder 12 is heated to maintain it in a high temperature so as to adjust the temperature and the viscosity to be in preferable conditions, if the resin stays in the cylinder 12 for long time, the resin is gradually carbonized through thermal decomposition. Thus, the resin changes to yellow color and/or carbonizes to be black dust, which seriously deteriorate quality of the molding products. Incidentally, as an derivative method of the comparison example, a hybrid method to use a screw as the piston is considered, however there is no change that the resin filled in the cylinder first is basically injected late, and the hybrid method still possesses the same problem.

Next, operation of the injection mechanism 10 related to the embodiment of the present invention will described. When the resin is filled into the cylinder 12, the piston 13 is moved backward by the unillustrated drive source to a position P1 where the resin filled in the cylinder 12 reaches to an predetermined amount. When this occurs, since the first check valve 16 allows a resin flow from the resin reservoir section RT toward the cylinder 12 via inlet path 11b, the resin is filled in the cylinder 12 from the resin reservoir section RT via the piping CP. Here, a fresh resin is supplied behind (piston side) the residual resin in the cylinder 12 which has not been injected in a previous injection stroke. The check valve here can be a passive valve which allows one way flow or an active stop vale which may actively opens and closes the flow path, possibly controlled by an electric signal and so force. Here, irrespective of the method, any valve which prevents back flow of the resin is called the check valve.

On the other hand, when the resin is fed form the cylinder 12 with pressure, the piston is moved forward to a position P2 (a position where a front surface of the piston reaches at an edge of the inlet port) by the unillustrated drive source. Whereby, a high pressure resin can be injected from the cylinder 12 via the outlet path 11a. On the other hand, since the first check valve 16 prevents back flow of the resin from the cylinder 12 toward the resin reservoir section RT via inlet path 11b, the resin once accumulated in the cylinder 12 doesn't return to the resin reservoir section RT. Incidentally, a stopper St to regulate the injection stroke of the piston 13 is provided.

According to the injection mechanism 10 related to the embodiment of the present invention, during the injection stroke to inject the resin material is repeated, since the piston 13 slides up to the position P2 in the cylinder 12, the resin at a vicinity of the piston 13 is replaced with the fresh resin supplied from the resin reservoir section RT, as the piston moves further backward. Thus in subsequent strokes, only fresh new resins can be injected. Therefore, the resin doesn't stay in the cylinder beyond the pot-life and start to cure or the viscosity does not become high. Also, since the foreign matters such as half-cured resin are not created, clogging of the resin flow path and inflow of the foreign matters into the molding cavity can be suppressed. As a result, since a consistent molding condition can be maintained, a product of high reproducibility and high accuracy can be obtained.

Advantageous effects of the injection machine 10 shown in FIG. 1 are summarized as follow.

(1) Irrespective of the viscosity of the resin material, the resin can be injected into the molding cavity with a high pressure and a high pressure injection molding is realized.

(2) By supplying the fresh resin to the metal mold, creation of the old and deteriorated resin can be suppressed.

(3) A homogeneous injection molding product having superior metal mold shape transfer characteristic can be obtained and in particular the molded optical element which is required to have a high accuracy and high transparency can be obtained efficiently.

The inlet port representing an open end where the inlet path 11b is open to the inside of the cylinder 12 is disposed at a piston side in respect to the outlet port representing an open end where the outlet path 11a is open to the inside of the cylinder 12.

Also, the piston 13 slides up to a position near to the inlet port or a position where the piston partially closes the inlet port in the cylinder at strokes to inject the resin material. Incidentally, the position near to the inlet port means a position to which the front surface of the piston 13 comes close so that the resin near the piston 13 can be replaced with the fresh resin supplied from the resin reservoir section RT. The position where the piston partially close the inlet port in the cylinder means a position where the piston partially close the inlet port but does not affect filling of resin.

Referring to FIG. 3, a second check valve is disposed to restrict the backflow of the resin material in the outlet path 11a, in addition to the example of FIG. 1. Functions of the second check valve 15 are to prevent the resin from flowing out from the outlet port 11a or, other way around, to prevent air commingling which is caused by the resin being suctioned as the piston 13 moves, when a resin having a very low viscosity is filled in the cylinder 12 from the inlet path 11b.

Operation of the injection mechanism related to the embodiment of the present invention will be described more specifically. When the resin is filled to the cylinder 12, the piston 13 is moved backward by the unillustrated drive source to the position P1 where a predetermined amount of the resin is filled in the cylinder 12. When this occurs, since the first check valve 16 allows flow of the resin towards the cylinder 12 via the inlet path 11b from the resin reservoir section RT, the resin is filled in the cylinder 12 via piping CP from the resin reservoir section RT. Here, the fresh resin is supplied behind (piston side) the resin remaining in the cylinder 12 which has not been injected in the previous injection stroke. On the other hand, the second check valve 15 prevents the back flow of air and the resin flowing towards the cylinder 12 from the molding cavity side via the outlet path 11a. Whereby, the fresh resin in the resin reservoir section RT is always supplied to the cylinder 12.

Contrarily, when the resin is fed from the cylinder 12 with pressure, the piston 13 is moved forward by the unillustrated drive source, up to the position P2. When this occurs, since the second check valve 15 allows resin flow towards the molding cavity from the cylinder 12 via outlet path 11a, the resin having can be injected with high pressure from the cylinder 12 via outlet path 11a. On the other hand, since the first check valve 16 prevents the backflow of the resin towards the resin reservoir section RT from the cylinder 12 via inlet path 11b, the resin once accumulated in the cylinder does not return to the resin reservoir section RT.

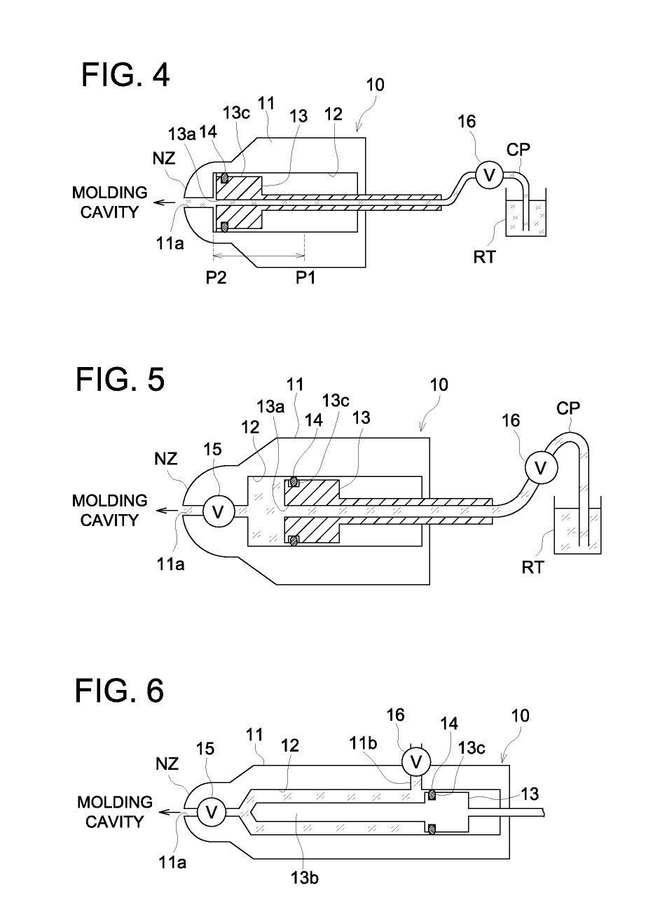

FIG. 4 is a schematic structural diagram of the injection mechanism related to an example of the present invention. With respect to the example in FIG. 1, in the injection mechanism 10, the inlet path of the housing 11 is eliminated and instead, a path 13a penetrating in an axis direction is formed in the piston 13, and the path 13a is connected to the resin reservoir section RT via the piping CP and the first check valve 16.

Next, operation of the injection mechanism 10 related to the embodiment of the present invention shown in FIG. 4 will be described. When the resin is filled into the cylinder 12, the piston 13 is moved backward by the unillustrated drive source. When this occurs, since the first check valve allows the flow of the resin towards the cylinder 12 from the resin reservoir section RT via the path 113a, the resin is filled in front of the piston 13 (between the piston 13 and the outlet path 11a) in the cylinder 12.

Contrarily, when the resin is fed from the cylinder 12 with pressure, the piston 13 is moved forward by the unillustrated drive source. Whereby, the high pressure resin can be injected from the cylinder 12 via outlet path 11a. On the other hand, since the first check valve 16 prevents the backflow of the resin towards the resin reservoir section RT via the outlet path 13a, the resin accumulated in the cylinder once does not return to the resin reservoir section RT. The present example is characterized in that the fresh resin can be always supplied to the piston 13 side, irrespective of a position of the piston 13 in the stroke.

Referring to FIG. 5, the second check valve 15 to restrict the resin not to return to the inside of the outlet path 11a is disposed in addition to the example in FIG. 4.

Operation of the injection mechanism 10 related to the embodiment of the present invention will be described more specifically. Incidentally, in the example of FIG. 5, an end of the injection stroke is in a position where the piston is moved further back in respect to the example in FIG. 4.

When the resin is filled in the cylinder 12, the piston 13 is moved backward by the unillustrated drive source. When this occurs, since the first check valve 16 allows the flow of the resin towards the cylinder 12 from the resin reservoir section RT via the passage 13a, the resin is filled in front of the piston (between the piston 13 and the outlet path 11a) in the cylinder 12. On the other hand, since the second check valve 15 prevents the back flow of air and the resin towards the cylinder 12 via outlet path 11a from the molding cavity side, the fresh resin in the resin reservoir section RT is supplied to the cylinder 12.

Contrarily, when the resin is fed from the cylinder 12 with pressure, the piston 13 is moved forward by the unillustrated drive source. When this occurs, since the second check valve 15 allows the flow of the resin toward the molding cavity via the outlet path 11a from the cylinder 12, the high pressure resin can be injected from the cylinder 12 via outlet path 11a. On the other hand, since the first check valve 16 prevents the backflow of the resin toward the resin reservoir section RT from the cylinder 12 via the outlet path 13a, the resin accumulated in the cylinder once does not return to the resin reservoir section RT.

The cylinder 12 is provided with a heat generating device such as a water jacket and a heater. By controlling the temperature using the temperature generating device such as the water jacket and the heater, the temperature of the resin in the cylinder 12 can be maintained consistently, as a result, molding with high reproducibility and less variation can be realized under a stable molding condition. Thus, the molding condition can be optimized precisely and the molding products can be readily molded with a high quality, also the molding products can be manufactured with a high quality and high yield constant. When the energy resin is used in particular, by cooling down the cylinder 12, the pot-life of the resin is extended and temperature rise of the cylinder 12 due to conduction of heat from the metal mold can be avoided, thus change of characteristic of the resin in the cylinder can be suppressed minimum and the variation of the quality of the molding product is reduced. While the heater 17 configures the temperature control device in the examples in FIG. 1 and FIG. 3, the temperature control device such as the heater 17 can be disposed in the configurations in FIG. 4 to FIG. 7.

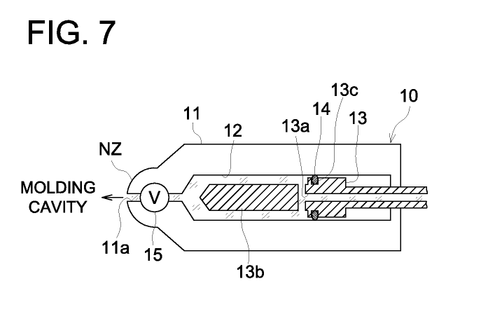

An example shown in FIG. 6, a projection section 13b spindling in a shape of a cylinder is formed at a front of the piston 13 (outlet path 11a side) in respect to the example in FIG. 3. Also, in an example shown in FIG. 7, a projection section 13b spindling in a shape of a cylinder is formed in front of the piston 13 (outlet path 11a side) in respect to the example in FIG. 5. The path 13a of the piston 13 branches at the cylinder side and is open to an outer circumference of the projection section 13b.

As above, by protruding the projection section 13b having a smaller diameter than an inner diameter of the cylinder 12 from the front surface of the piston 13, a space in a shape of a tube is created between an inner wall of the cylinder 12 and the projection section 13b, thus an amount of the residual resin, which is leftover of injection, in the inlet path 11b through which the resin is supplied in the cylinder 12 or in a space from the path 13a of the piston 13 to the outlet path 11a can be reduced. Thus since number of shots i.e. from filling the resin in the cylinder 12 to injection can be reduced, change of characteristic of the resin can be further suppressed.

In FIG. 6 and FIG. 7, the heat generation device such as the water jacket and the heater can be disposed inside the projection section 13b. While an area of the projection section 13b, provided in front of the piston 13, which contacts with the resin is relatively large, since the resin contacting with the projection section 13b is limited by a capacity of the space in the shape of the tube in the circumference of the projection section 13b, the temperature of the resin can be controlled with high accuracy by temperature control through the water jacket or the heater. Therefore, molding condition can be steady and molding with high reproducibility and less variation can be realized. As a result, the molding condition can be optimized precisely, and the molding product can be readily molded with a high quality, thus the molding products can be manufactured with a high quality and high yield constant.

Also, when the energy curable resin is used, by cooling down the projection section 13b of the piston, the pot-life of the resin is extended and change of the characteristic of the rise in the cylinder 12 is suppressed minimum, then the molding reproducibility is enhanced and the reproducibility of the quality of the molding product is also enhanced.

The resin material filled in the injection mechanism related to the embodiment of the present invention is the energy curable resin. The energy curable resin means a resin cured by giving energy such as heat and light from the outside. The energy curable resin is generally in the form of a liquid having a low viscosity in a room temperature in many cases. Thus, the injection mechanism of the present invention which can ensure a high hermetic characteristic and high molding pressure is preferable, and by applying the present invention, a shape transfer characteristic of the molding product and a uniformity of the quality can be enhanced.

As the energy curable resin, for example, a thermosetting resin and an ultraviolet curable resin are cited. Since the thermosetting resin becomes hardened by heat, it can be solidified by supplying the thermosetting resin in the form of a liquid at room temperature to a heated metal mold. On the other hand, since the ultraviolet curable resin is hardened by radiating ultraviolet ray, it can be hardened by radiating the ultraviolet ray form outside after supplying the ultraviolet curable resin in the form of a liquid at room temperature in a transparence mold.

The injection molding machine having the injection mechanism of the present invention capable of realizing uniform injection molding having a high mold transferability enables high accuracy, high quality, high yield rate and namely low cost production.

The optical element molded by the injection mechanism 10 related to the embodiment of the present invention is molded under a high molding pressure, thus the optical element has a superior optical surface having a small contraction percentage and a high shape transferability of the optical surface of the metal mold. Also, since the deteriorated resin is not created, a uniform optical characteristic is possessed, thus extremely high quality and optical performance can be realized.

As the “optical elements”, for example, a lens, a prism, a diffraction grating optical element (a diffraction lens, a diffraction prism, and a diffraction plate), an optical filter (a space low pass filter, a wavelength band pass filter, a wavelength low pass filter, a wavelength high pass filter and so forth), a polarized filter (an analyzer, an azimuth rotator, and a polarization separation prism), and a phase filter (a phase plate, and a hologram) are cited without being limited to the above optical elements.

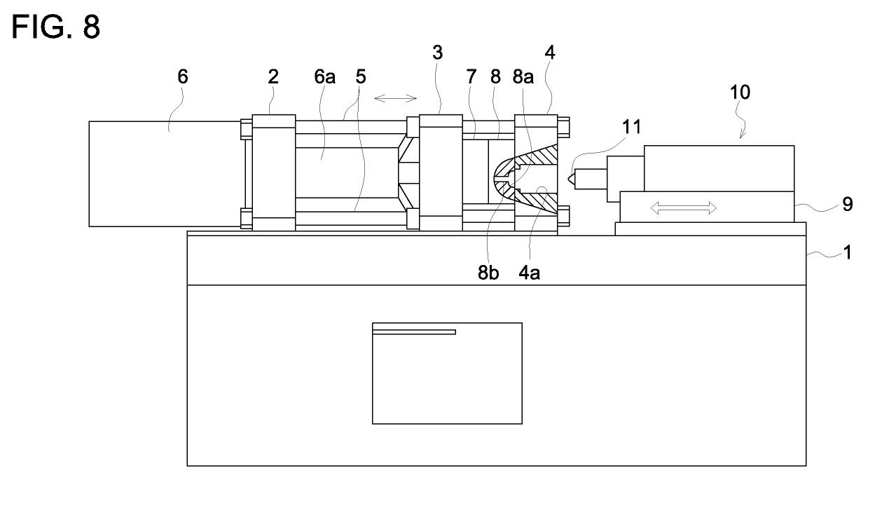

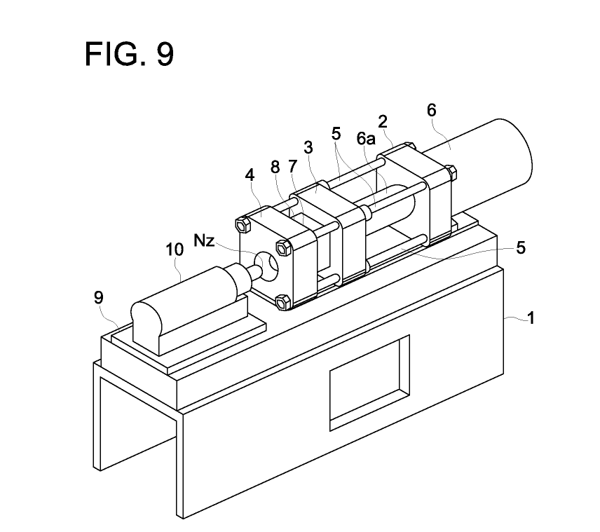

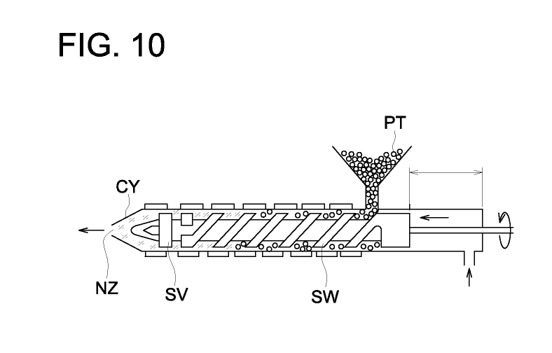

FIG. 8 is a side view of an injection molding machine related to the embodiment of the present invention. FIG. 9 is a perspective view of an injection molding machine related to the embodiment of the present invention.

In FIG. 8, a base 1 is mounted on a surface plate. On a top surface of the base 1, a cylinder plate 2 in a shape of a relatively thick plate, a movable side die plate 3, and a fixed side die plate 4 are disposed in the above order from the left side. Between the cylinder plate 2 and the fixed side die plate 4, four tie bars in a round shape are disposed in parallel to the top surface of the base 1. While the cylinder plate 2 and the fixed side die plate 4 are fixed onto the base 1, the movable side die plate 3 is movable alone the tie bars 5.

At the cylinder plate 2, a mold clamping cylinder 6 is disposed and the mold clamping piston 6a of the cylinder thereof is connected to the movable side die plate 3. At a fixed die plate 4 side of the movable die plate 3, a movable die 7 is disposed, and at a movable metal mold side of the fixed side die plate 4, the fixed metal mold 8 is disposed. While it is not illustrated, an inside of clamped the movable metal mold 7 and the fixed metal mold 8, a molding cavity is formed. The molding cavity is communicated with a spool 4a formed inside the fixed side die plate 4 via a runner inside the fixed metal mold 8.

On the base 1, a movable table 9 is disposed adjacent to the fixed side die palate 4 and on the movable table 9, there is disposed the injection mechanism 10 having been described with reference to FIG. 1 to FIG. 7. The injection mechanism 10 is provided with an injection nozzle NZ to be seated on a receiving surface 8a of the fixed metal mold 8 through a through hole 4a of the fixed side die plate 4.

Next, operation of the injection molding machine related to the embodiment of the present invention will be described. First, when a hydraulic pressure is applied inside the mold clamping cylinder 6, the piston 6a displaces to the right hand in FIG. 8 and drives the movable side die plate 3 to the right hand. When the movable side die plate 3 moves to the right hand, the movable metal mold 7 also moves to the right, being pushed by the plate 3, and firmly contacts with the fixed metal mold 8.

In the above state, when the thermosetting resin in the form of a liquid is supplied from the injection mechanism 10, the thermosetting resin is injected to the spool 8b of the fixed metal mold 8 via the outlet path 11a of the injection nozzle NZ, then from here, through an unillustrated runner, the resin is injected with pressure inside the molding cavity in the metal molds 7 and 8 heated by unillustrated heater. The thermosetting resin heated by surfaces of the metal molds 7 and 8 becomes hardened in the shape of the molding cavity. After being hardened, the pressure in the mold clamping cylinder 6 is reduced and the molds are opened by displacing the piston 6a to the left hand so that the molding product is taken out.

As above, the embodiments of the present invention have been described. It is to be understood that changes and variations may be made without the present invention being limited to the embodiments thereof. The present invention can be applied without being limited to the energy curable resins.

1-12. (canceled)

13. An injection mechanism to inject a resin material into a molding cavity used in a molding machine comprising:
a reservoir section to reserve the resin material;
a cylinder having;
an outlet port to inject the resin material from the cylinder, and
an inlet port, provided at a different position from the outlet port, to supply the resin material reserved in the reservoir section in the cylinder;
a piston to slide inside the cylinder; and
a first check valve to restrict backward flow of the resin material provided between the inlet port and the reservoir section.

14. The injection mechanism of claim 13, wherein the inlet port is provided at a piston side in respect to the outlet port.

15. The injection mechanism of claim 14, wherein the piston slides within the cylinder up to a position near to the inlet port or a position to close a part of the inlet port in a stroke to inject the resin material.

16. The injection mechanism of claim 13, wherein a second check valve to restrict backward flow of the resin material is provided between the outlet port and the molding cavity.

17. An injection mechanism to inject a resin material into a molding cavity used in a molding machine comprising:
a reservoir section to reserve the resin material;
a cylinder having an outlet port to inject the resin material from the cylinder,
a piston to slide inside the cylinder having a passage to supply the resin material reserved in the reservoir section to the cylinder; and
a first check valve to restrict backward flow of the resin material, located between the passage and the reservoir section;
wherein the resin material supplied via the passage is accumulate between the piston and the outlet port in the cylinder.

18. The injection mechanism of claim 17, wherein a second check valve to restrict backward flow of the resin material is provided between the output port and the molding cavity.

19. The injection mechanism of claim 13, further comprising a temperature control device to control temperature of the cylinder.

20. The injection mechanism of claim 13, wherein a projecting section extending towards the outlet port is provided at a portion of the cylinder in the cylinder so as to create a space in a shape of a circular tube between an inner wall of the cylinder and the projecting section.

21. The injection mechanism of claim 20, further comprising a temperature control device to control temperature of the projecting section.

22. The injection mechanism of claim 13, wherein the resin material is an energy curable resin material.

23. A molding machine having the injection mechanism of claim 13.

24. An optical element molded by the molding machine of claim 23.
